(19) United States
(12) Patent Application Publication
(10) Pub. No.: US 2015/0161596 A1
(43) Pub. Date: Jun. 11, 2015

(54) TOKEN USED IN LIEU OF ACCOUNT IDENTIFIER

(71) Applicant: ALLIANCE MESSAGING LIMITED, Killorglin (IE)

(72) Inventor: Denis McCarthy, Killorglin (IE)

(73) Assignee: ALLIANCE MESSAGING LIMITED, Killorglin (IE)

(21) Appl. No.: 14/562,004

(22) Filed: Dec. 5, 2014

Related U.S. Application Data
(60) Provisional application No. 61/912,364, filed on Dec. 5, 2013.

(51) Int. Cl. G06Q 20/36

(52) U.S. Cl. CPC G06Q 20/3674

(57) ABSTRACT

A card transaction is processed at a merchant with a token in lieu of a card number (PAN) placed in an authorization message sent to a transaction processing system. The token is obtained from a tokenization service with alphanumeric characters that are not usable as the PAN in the event the merchant's system is breached. A transaction processing system receives the authorization message from the merchant and determines whether a token is present. If present, the transaction processing system requests a PAN from the tokenization service and replaces the token with the PAN.

### CROSS REFERENCES TO RELATED APPLICATIONS

This application claims the benefit of and is a non-provisional of U.S. Provisional Application Ser. No. 61/912,364 filed on Dec. 5, 2013, which is hereby expressly incorporated by reference in its entirety for all purposes as if fully set forth herein.

### BACKGROUND OF THE INVENTION

Payment card data theft is a major issue within the payment card industry (PCI). Data theft sometimes results from system breaches at entities involved in processing payment card transactions. Such entities include merchant organizations that receive credit card information from a cardholder, such as a card or account number, in order for a cardholder to subsequently conduct a transaction. For example, a hotel, airline, car rental agency or other entity involved with reservations may require a card number up front in order to hold a reservation and guarantee payment when the transaction is completed. As another example, a merchant or other organization may hold credit card information when a customer has recurrent payments (e.g., monthly payments on an account) and uses the card number each month in order to process the payments.

Various regulations and standards have been developed to protect consumer card information when it is held by a merchant or other entity. For example, the PCI Data Security Standard is a payment card industry standard intended to be followed by organizations that store, process or transmit cardholder data. Among other things, the standard provides measures to be taken to protect card data when stored, including the tokenization of card numbers. Tokenization involves replacing a card number with a random value or token, which protects a credit card number in the event the system storing the card information is breached. Tokens are typically provided by a tokenization service—an entity or system that provides a token to a merchant in response to a primary account number (PAN) that a merchant has received from a cardholder. The tokenization service stores and links the token to the actual PAN in its database systems, so that the actual PAN can be later retrieved and provided to the merchant upon request.

Tokenization does lead to some complexities in the use of payment cards (credit cards, debit cards and other forms of transaction cards). For example, under current practice, a merchant (or a merchant payment processor acting on behalf of a merchant) using tokenization receives a PAN from the cardholder, transmits the PAN to the tokenization service to receive a token, stores the token for subsequent use when a transaction is to be completed, contacts the tokenization service again to obtain the PAN in exchange for the token, and then uses the received PAN to process the transaction. Using the token to obtain the PAN is often referred to as “de-tokenization” and requires extra steps by the merchant and the merchant's system.

### BRIEF SUMMARY OF THE INVENTION

There is provided, in accordance with embodiments of the invention, methods and systems for using a token in lieu of an account identifier (such as a primary account number or PAN). In described embodiments, the token may be included in an authorization message (request) sent by a merchant (or a merchant payment processor) so that the merchant has no need to retrieve a PAN represented by the token. In embodiments, a transaction processing system receiving authorization messages checks those messages for tokens. The presence (or lack of presence) of tokens in authorization messages can be used advantageously by the transaction processing system to confirm merchant compliance with token policies and also to evaluate as an indication of potential fraud.

In one embodiment, a method for processing a transaction against an account having an account identifier includes: receiving, at a payment processing system, an authorization request message from a merchant system, the authorization request message including a token for use in lieu of an account identifier, the token provided to the merchant system by a tokenization service and linked to the account identifier for the account; providing, to the tokenization service by the payment processing system, the token in the authorization request message received from the merchant system; receiving, by the payment processing system from the tokenization service, the account identifier linked to the token; and forwarding, by the payment processing system to a financial institution maintaining the account, the authorization request message, the forwarded authorization request message including the account identifier linked to the token.

### BRIEF DESCRIPTION OF THE DRAWINGS

FIG. 1 is a block diagram of a payment processing network using tokens, in accordance with embodiments of the invention.

FIG. 2 is a simplified flow diagram illustrating processing of a payment card transaction in accordance with some embodiments of the invention.

FIG. 3 is a diagram illustrating an authorization message sent by a merchant system to a payment processing system.

FIG. 4A is a detailed flow diagram illustrating the processing of a payment card transaction by a merchant/hotel in accordance with one embodiment of the invention.

FIG. 4B is a flow diagram illustrating a process within the flow diagram of FIG. 4A, in order to evaluate transactions based on the presence of a token in an authorization message.

FIG. 5 is a block diagram illustrating an exemplary computer system upon which embodiments of the invention may be implemented.

### DETAILED DESCRIPTION OF THE INVENTION

There are various embodiments and configurations for implementing the present invention. Generally, embodiments involve the use of tokenization, such that a merchant or other entity involved with a card or similar transaction obtains a token to be stored in lieu of a payment card number (e.g., a primary account number or “PAN”) or other account identifier.

In disclosed embodiments, the token is obtained from a tokenization service, which can be associated with a transaction processing system. The token is used by a merchant for processing a transaction (e.g., sending an authorization message to the transaction processing system). The merchant has no need for the PAN other than to initially request a token from the tokenization service. Once the token is requested and obtained from the tokenization service, the merchant thereafter uses the token (and not the actual PAN) to complete the transaction, such as by placing the token in the PAN field of the authorization message.

In some embodiments, an authorization message is processed by a transaction processing system (acquirer system), with the acquirer system parsing and evaluating the message to determine whether the value in the PAN field of the message is an actual PAN or a token. If the PAN field is populated with a token, the acquirer system sends a request to the tokenization service to request the actual PAN, and thereafter processes the transaction using the PAN (e.g., by forwarding the authorization message to the financial institution issuing the payment card).

In some embodiments, the presence of an actual PAN (rather than a token) in an authorization message can be used by a transaction processing system to determine whether a merchant and/or its employees are following merchant policies regarding the protection of consumer card information and to evaluate a transaction for possible evidence of fraud.

While disclosed embodiments describe transactions using a payment card in the form of a credit card, it should be understood that the present invention has application to any form of instrument used for conducting a transaction against an account, including, but not limited to, credit cards, debit cards, check cards, loyalty cards, ATM cards, gift cards, stored value cards, smart cards, key fobs, and other instruments that are used by consumers to process a transaction and that provide a card number or other identifier associated with an account against which the transaction is being posted. Also, while the disclosed embodiments refer to the use of a token to represent a PAN, it should also be appreciated that a token could also be generated to represent other sensitive information of the cardholder that might be provided as part of a card transaction, such as a card expiration date.

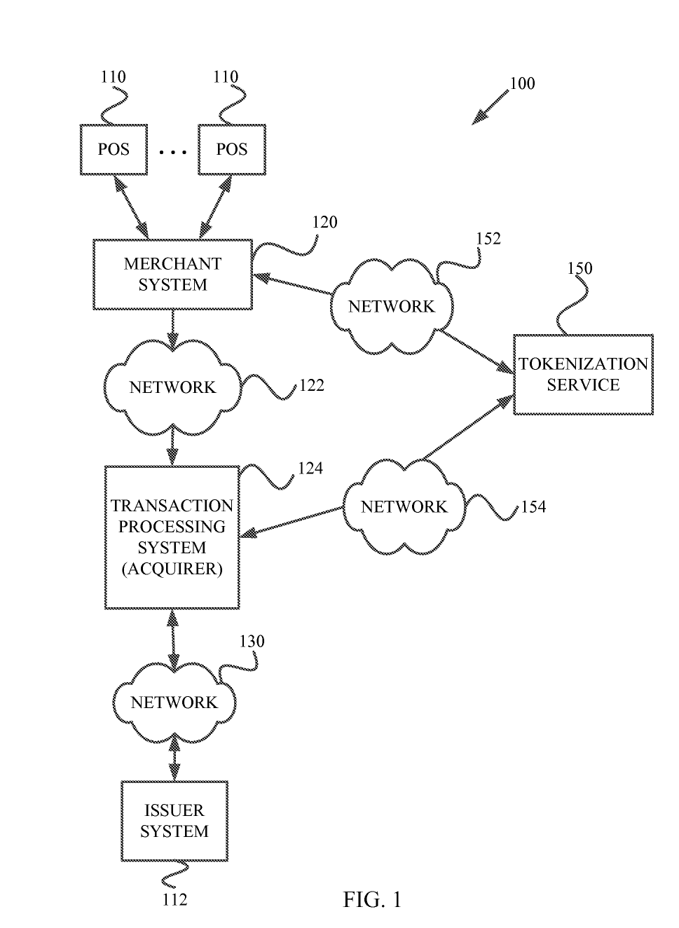

Turning now to FIG. 1, a payment network 100 is illustrated. In the network 100, credit card transactions conducted at point-of-sale (POS) terminals 110 are processed and posted against card accounts maintained at an issuer system 112. In the illustrated embodiment, the point-of-sale terminals 110 may be at one or more locations of a merchant entity (e.g., retail store, hotel, or other entity providing goods or services) and may be used to process transactions that a consumer conducts against an account at a financial institution operating the issuer system 112. However, it should be appreciated that the network 100 is simplified and that, in most environments, POS terminals 110 may be located at many different merchants or merchant entities, and that card transactions may be conducted at any one of the point-of-sale terminals against accounts maintained at many different financial institutions.

In the network 100, the POS terminals 110 are connected to a central merchant system 120 which processes and forwards card transactions through a communications network 122 to a third party transaction processing system (acquirer) 124. The transaction processing system 124 may represent systems maintained by one or more entities that process transactions on behalf of multiple merchants and then forward those transactions through a communications network 130 to issuer system 112. While, for ease of describing embodiments of the invention, the transaction processing system 124 is illustrated as a single system, it should be appreciated that there may be multiple parties and multiple systems involved in the flow of transactions between a merchant and a financial institution, such as a merchant payment processor that has arrangements with a specific merchant to process and forward card transactions on behalf of that merchant, a third party acquirer that obtains transactions from multiple merchants and/or their merchant payment processors (and uses the Issuer Identification Number—often also referred to as a Bank Identification Number—included in each PAN to route transactions to the appropriate issuer), a card association (such as Master Card, VISA, AMEX or Discover) that may operate some of the computer systems involved in processing and reconciling card transactions, and third parties that may operate the issuer system 112 and similar systems on behalf of various financial institutions for purposes of issuing cards and maintaining accounts for those financial institutions. The payment network 100 as thus far described is conventional and the various parties and systems involved are known to those skilled in the art.

Also seen in FIG. 1 is a tokenization service/system 150 connected to the merchant system 120 by a communications network 152 and connected to the transaction processing system 124 by a network 154. The tokenization service 150 comprises various systems that generate and store tokens and communicate with the merchant system 120 and the transaction processing system 124 for purposes of using tokens in lieu of account numbers for conducting transactions. The tokenization service 150 receives a payment card number from the merchant system 120 (an account number that is been provided by the cardholder to the merchant) and generates a token that is provided to the merchant system 120. The token is stored by the merchant system in order to conduct transactions against the account (in some cases, a merchant payment processor may act on behalf of a merchant and may be the party storing/using a token in order to conduct transactions against the account on behalf of a merchant, and hence the term “merchant” as used herein is meant to include such a merchant payment processor).

The tokenization service 150 generates random tokens corresponding to payment card numbers and maintains one or more databases that store encrypted payment card numbers, along with the corresponding token generated for each payment card number (PAN), so that tokens and corresponding payment card numbers are linked. The generated token numbers are provided to a merchant when a payment card number is provided by the merchant. When that same token is later provided by an authorized party to the tokenization service, the tokenization service can provide the corresponding actual payment card number. The tokenization service 150 and its implementing systems are also known to those skilled in the art and are described, as examples, in “Tokenization (Data Security)” at http://en.wikipedia.org/wiki/Tokenization_(data_security), and in “PCI DSS Tokenization Guidelines” at https://www.pci securitystandards.org, as well as in numerous prior patents and patent publications.

In some embodiments, the presence of an actual PAN (rather than a token) in an authorization message can be used by a transaction processing system to determine whether a merchant and/or its employees are following merchant policies regarding the protection of consumer card information and to evaluate a transaction for possible evidence of fraud.

The particular format of tokens generated by the tokenization service 150 depends on the particular preferences of the tokenization service and its customers. For example, in some instances the token may have the same or a different number of digits as the card number that it represents. In other cases, the token may include part of the PAN, such as the payment card type (the first 2 digits of a credit card number have values that typically represent the card type, such as Master card, Visa and American Express). In some cases the token may include the last four digits of the PAN so that, if needed, the merchant or other party having possession of the token may confirm the card number with a customer without having the entire PAN. However, at least some portion of the token comprises a string of alphanumeric data bits, randomly generated by an algorithm or other encryption method at the tokenization service, in order to make the possession of the token not useful for identifying the complete, actual PAN (e.g., if the merchant system storing the token were to be breached).

Also, it should be noted that the networks 122, 130, 152 and 154 illustrated in FIG. 1 may be any form of communications network for purposes of communicating data between the respective systems, including private networks and/or public networks (such as the Internet). While such networks in FIG. 1 are represented as separate networks, in actual practice some or all of the networks may be part of a larger, integrated communications network.

In accordance with embodiments of the invention, when a token is requested by the merchant system 120 (by forwarding a PAN through network 152 to the tokenization service 150), that token is thereafter used by the merchant system 120 to process a transaction without having to store or use the actual PAN. Further, in accordance with some embodiments of the invention, the token may have the same number (or a consistent usable number) of digits in relation the actual PAN, so that the token may be used to populate the PAN field of an authorization message when sent from the merchant system 120, in a manner to be described shortly. Further, in accordance with embodiments, when the transaction processing system 124 receives an authorization message from the merchant system 120, the token populating the PAN field may be used in a request by the transaction processing system to the tokenization service 150 to retrieve the actual PAN corresponding to that token, in a manner also to be described shortly (among other things, the transaction processing system may need the actual PAN in order to know where to route the transaction).

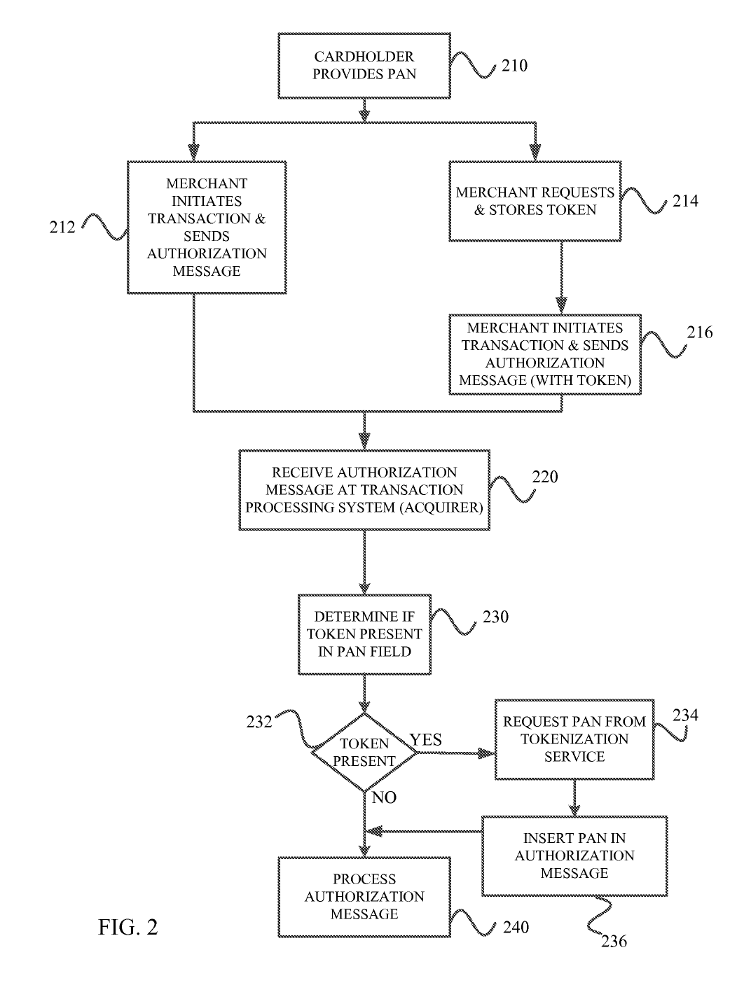

FIG. 2 illustrates a process implemented within the network 100 for processing transactions using a token in lieu of a PAN. At step 210, the cardholder provides the PAN to a merchant, e.g., in order to conduct the transaction or guarantee payment for a subsequent transaction. If the transaction is being conducted in real time when the cardholder provides the PAN, the merchant initiates the transaction and may directly send an authorization message to the transaction processing system 124, step 212. Such a step occurs when the merchant has no need to store the PAN, but rather is immediately conducting the transaction for the cardholder. For example, if a transaction is being conducted at a retail merchant location where the cardholder is purchasing a product, a clerk at one of the POS terminals 110 may swipe a credit card to read the PAN and insert the PAN into an authorization message (request) that is sent in order to authorize/approve the transaction at the issuer system 112. In such a circumstance, the merchant is not requesting a token since it is not storing the PAN and has no need for the PAN other than to request authorization for the transaction.

As explained earlier, in some circumstances, a merchant (or a merchant payment processor acting on behalf of a merchant) does need to store the PAN (or a token that can be used to retrieve the PAN), such as when a transaction is to be completed later but the merchant needs assurance that a PAN is available to properly complete the transaction. One example of such a circumstance is a card (and card number) being provided to a hotel when a customer makes a reservation at the hotel. In such case, the merchant will use the card number to later conduct a transaction against the card account and so, in lieu of storing the PAN provided by the cardholder, the merchant requests a token from the tokenization service 150 and stores the token at the merchant system 120, step 214. Later, when the transaction is to be completed, the merchant uses the stored token in order to initiate the transaction and sends an authorization message, with the token, to the transaction processing system 124, at step 216.

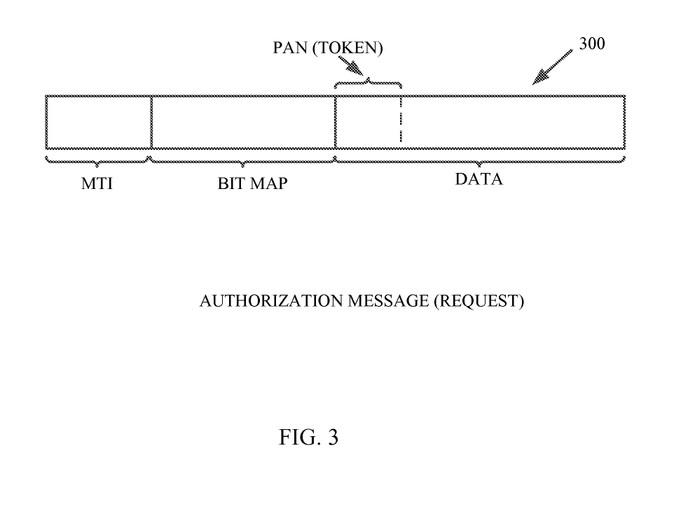

Referring briefly to FIG. 3, an authorization message 300 into which a token has been inserted by a merchant system 120 is illustrated. Such a message is used to request authorization to complete the transaction and is sent, via the transaction processing system 124, to the issuer system 112. As an example, the message 300 may be formatted in accordance with the ISO 8583 standard (see, e.g., “ISO 8583” at http://en.wikipedia.org/wiki/ISO_{—}8583) and can be seen as having three primary parts, a message type indicator (MTI) field, a Bit Map field, and a Data field.

The MTI field is typically a four digit numeric field that classifies the high-level function of the message and, in the case of the message seen in FIG. 3, indicates that the message is an authorization message to determine if funds are available and to request approval to post the transaction to an account (while not part of the presently described embodiment, other message types may be used to complete a transaction, such as an authorization reply message from the issuer system 112 to the merchant, indicating whether or not the card transaction has been approved).

The Bit Map field is a field within the message that indicates the data elements that are present in the message. For example, one such indicated data element would be a PAN field illustrated in FIG. 3 which, in conventional messages, would include the PAN for the card being used in the transaction.

The Data field includes multiple data elements having transaction information needed for a transaction, such as a PAN field. In accordance with embodiments of the invention, the PAN field of the message 300 illustrated in FIG. 3 contains a token (populating the PAN field rather than the actual PAN of the card used in the transaction), such as the token requested and stored by the merchant at step 214 in FIG. 2.

Returning to FIG. 2, the authorization message initiated by the merchant at either step 212 or step 216 is received at the transaction processing system 124, step 220. The transaction processing system determines, at step 230, whether the PAN field of the authorization message has an actual PAN or a token. Various methods can be implemented at the transaction processing system 124 to determine whether a token or a PAN occupies the PAN field.

For example, the message could be parsed to evaluate the PAN field, and a token may be indicated by a marker bit within the token, such as a “0” occupying the first bit of the PAN field. As known to those familiar with a payment card numbering, a “0” is not normally used in the first bit in current numbering schemes of a PAN (the first two digits of a PAN represent the card type, and current numbering schemes for card types do not begin with the “0” value). Many other methods for identifying a token are possible. For example, the transaction processing system 124 could evaluate certain digits of the data string in the PAN field (such as the BIN—Bank Identification Number—that could comprise the first few bits, e.g., first four bits, of the data string and that identify the issuer/bank maintaining the card account), and use a look-up table to determine whether those digits are consistent with the values that might be found in a PAN or values that might be found in a token. Specifically, a bank or issuer could have two BINS that identify the bank issuing the card, with one BIN used with/forming part of an actual PAN and the other BIN used with/forming part of any token (used in lieu of a PAN for a tokenized transaction). As should be apparent, the particular method used for identifying a token may depend on the particular format used by the tokenization service 150 for tokens that it generates, and the transaction processing system 124 may evaluate the PAN field based on different formats that it expects from tokenization services used by the merchant system 120. In one embodiment, the token may have the same number of bits as the PAN (in order to occupy the same number of bits as the PAN would occupy in the PAN field). In other embodiments the token may have fewer or more bits than the PAN, and could occupy the PAN field and/or another unused portion of the Data field, as long as the transaction processing system “knows” that a token is present (by virtue of a marker bit or distinguishing bits of a token, as provided in the authorization message).

If the transaction processing system 124 determines that a token is present (a “yes” at step 232), a request (that includes the token) is made to the tokenization service 150 for the corresponding PAN, step 234. The PAN retrieved by the transaction processing system is inserted into the authorization message to replace the token, step 236, and the authorization message is processed and forwarded to the issuer system 112, step 240.

If, the transaction processing system 124 determines that the PAN field of the authorization message does in fact have a PAN rather than a token (a “no” at step 232), then the process proceeds directly to step 240 and the message, with the PAN as received from the merchant, is processed and forwarded to the issuer system 112.

In the foregoing description, it is assumed that the evaluation of an authorization message (to determine whether a token occupies the PAN field) occurs at the transaction processing system (acquirer) 124. It should be appreciated that this functionality could be implemented in software applications either at the transaction processing system or in other systems associated with the transaction processing or otherwise involved in the flow of authorization messages between the merchant system 120 and the issuer system 112. Thus, in an alternative embodiment, a separate system (such as pass-through switch) could be placed in the flow (on either side of the transaction processing system 124), and could perform steps to 230-236.

Although not illustrated in FIG. 2, it should also be appreciated that, since the network 100 is intended to eliminate the need for a merchant to store and use a PAN, when a response message is returned from the issuer system 112 (a authorization response message from the issuer system 112 indicating whether or not the transaction is approved), in some embodiments the transaction processing system 124 (or an associated system) perform steps similar to steps 230-236, but in reverse. For example, authorization messages (both requests and responses) include, within their respective data fields, a transaction identifier or reference number which enables the merchant system 120 to match-up a response message to the original authorization request message for the same transaction. The transaction processing system 124 may store transaction identifiers (and an indication of whether a token was originally provided by a merchant for that transaction). Each response message (with a PAN in the PAN field) from the issuer system 112 may be evaluated to determine if the transaction is one for which a token was provided to the transaction processing system by the merchant system 120. If so, the transaction processing system 124 requests from the tokenization service 150 the token corresponding to the PAN, places the token in the PAN field in lieu of the PAN, and returns that message to the merchant system 120. Alternatively, the transaction processing system could retain and store the token when it processes the original authorization request message (e.g., store the token in association with the transaction identifier), and then reinsert the token into the authorization response message when it is to be returned to the merchant system 120 (thus eliminating the need for the transaction processing system to again request the token from the tokenization service).

As mentioned earlier, in one embodiment the tokenization service is implemented at the transaction processing system 124 (or at a switch or other system associated with the system 124), thus simplifying communications (the merchant only needs to communicate with the transaction processing system when requesting a token and when processing transactions that might use a token) and streamlining de-tokenization by having actual PANs associated with tokens available for access in order to process transactions at the transaction processing system.

Thus, in each of the described embodiments, the merchant system 120 is not in possession of the PAN, either when the transaction is initiated by the merchant or when a response message is received from the transaction processing system by the merchant.

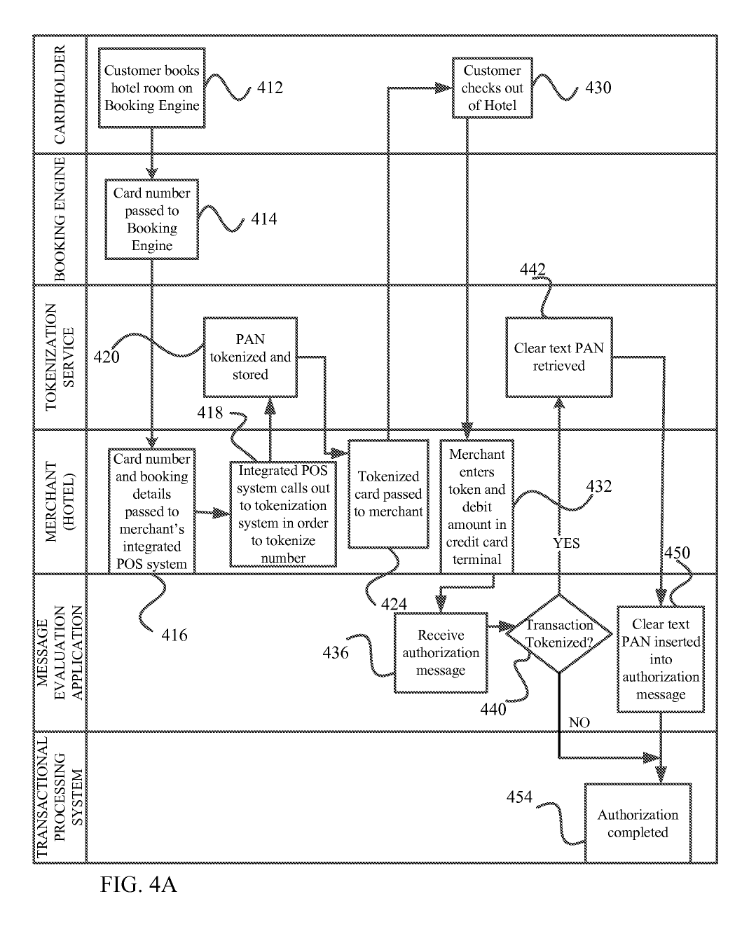

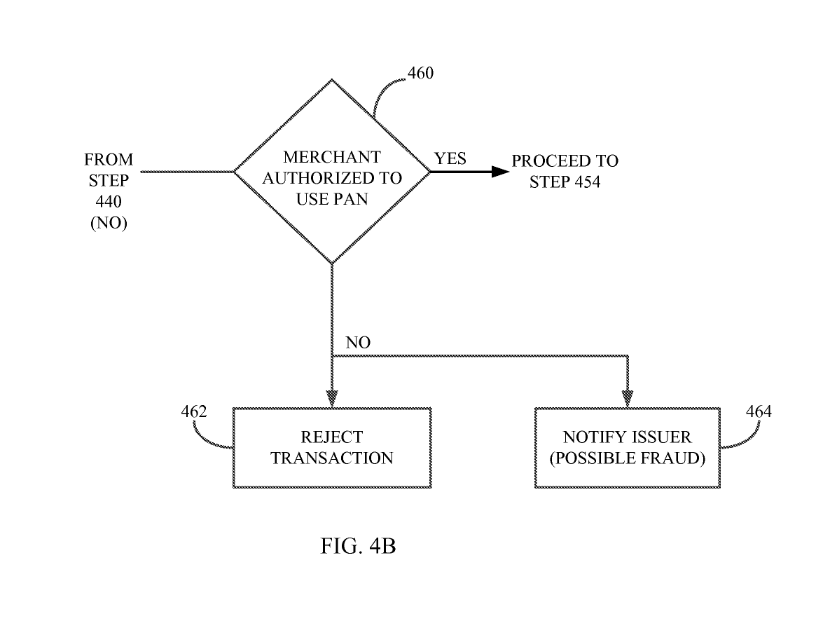

FIG. 4A illustrates a more detailed flow diagram in accordance with one embodiment of the invention. In this described embodiment, the merchant is a hotel and the cardholder provides a card number to a booking engine (operated by the hotel, or on behalf of the hotel by a third party). Various steps illustrated in FIG. 4A are presented to show each party (and its systems) that are involved performing those steps. Accordingly, FIG. 4A shows the parties involved as a “Cardholder,” a “Booking Engine,”, a “Tokenization Service,” a “Merchant (Hotel),” a “Message Evaluation Application,” and a “Transaction Processing System.” By way of explanation, the Booking Engine is a system to which a cardholder provides a card number in order to guarantee a reservation and to also have a card account against which the cost of the hotel room is charged when the cardholder checks out. The Message Evaluation Application is a software module that performs steps similar to the steps 230-236 described above in conjunction with FIG. 2, and can be resident at the transaction processing system 124, in a separate system associated with the transaction processing system 124, or in another system or switch placed in the flow of messages between the merchant and the issuer system.

In FIG. 4A, the process begins with a customer booking a hotel room using the booking engine, step 412. As one example, the booking engine could be implemented at a website operated by the hotel or by a third party, and card information could be entered either by the customer (e.g., using the website) or by an employee of the hotel or a third-party booking agent, using a terminal such as one of the earlier described POS terminals 110. The customer's card number is passed to the booking engine at step 414. At step 416, the card number and booking details are provided by the booking engine to the hotel's integrated point-of-sale (POS) system, which may be the same or similar to the earlier described merchant system 120 (as linked to the POS terminals 110).

At step 418, the integrated POS system calls out to the tokenization service (and provides the customer's card number to the tokenization service) in order to obtain a token representing the card number (PAN). At step 420, the tokenization system tokenizes the PAN (generates a token) and stores the token (in association with the PAN) for future reference. The tokenization service also passes the token to the hotel at step 424, where it may also be stored. For purposes of the present description, it is assumed that the customer checks into the hotel, with the hotel integrated POS system (such as merchant system 120) recognizing that the customer has previously provided card information and that further card information is not needed from the customer (other than perhaps verifying the last 4 digits of the customers card number, which may be included within the token as described earlier).

When the customer checks out the hotel, step 430, the hotel system enters the token and the amount of the transaction at a credit card terminal (POS terminal) for processing the transaction against the customer's card by creating an authorization message, step 432. The authorization message is received by the Message Evaluation Application at the transaction processing system 124, step 436, which determines whether the transaction has been tokenized (i.e., a token has been inserted in the PAN field of the authorization message), step 440. If the authorization message has a token, as determined in step 440, the transaction processing system requests that a clear text PAN (i.e., a non-tokenized PAN) be retrieved from the tokenization service 150. The Message Evaluation Application receives the PAN and inserts the PAN into the authorization message, step 450, and forwards it through the transaction processing system to the issuer in order to complete the authorization (step 454) and request approval by the card issuer. If the authorization message does not have a token in the PAN field of the authorization message, step 440, then the authorization message is directly passed by the Message Evaluation Application to the transaction processing system in order to complete the authorization (step 454) and request approval by the card issuer.

FIG. 4B illustrates a sub-process within the transaction processing process seen in FIG. 4A. As mentioned earlier, the tokenization of card numbers by systems at the transaction processing system 124 enable the system 124 to determine if the merchant is complying with its own policies regarding use of tokens or if there is evidence of fraud. As an example, the transaction processing system 124 may look for errors in the handling of data by merchants (a merchant may be using a PAN, when in fact it is to be using a token) and recognize possible fraudulent activity by an entity acting as or acting through a merchant in conducting transactions. In the embodiment illustrated in FIG. 4B, the Message Evaluation Application may be resident at the transaction processing system 124 (or any system associated with the transaction processing system) to evaluate transactions based on the presence of a token or a PAN in the authorization message received at the transaction processing system from a merchant. Generally, in the illustrated embodiment transactions may be rejected if a merchant (or a purported merchant) attempts to conduct a transaction using an actual PAN, and in some cases the transaction processing system may notify a card issuer of potential fraud when an actual PAN is received when the merchant in question should be using a token.

In particular, when the transaction is determined at step 440 (FIG. 4A) to not be tokenized (the authorization message contains an actual PAN of a cardholder) the Message Evaluation Application (or another application at the transaction processing system) determines whether the merchant from whom the authorization message is received is one from whom tokens are to be used. It should be appreciated that some merchants might continue to use an actual PAN in some cases (such as a merchant that is transitioning away from using actual PANs to using tokens), but ideally most merchants should be using tokens exclusively in order to protect customer credit card information. Thus, at step 460 in FIG. 4B, it is first determined if the merchant is recognized as authorized to be using an actual PAN rather than a token (e.g., a merchant identifier in the authorization message can be checked against the table that is maintained by the transaction processing system 124 and that indicates whether the identified merchant is to be using a PAN or a token). If the merchant is authorized to submit transaction messages using an actual PAN at step 460, then the process proceeds to step 454 (FIG. 4A) and the transaction is completed using the PAN. If, on the other hand, the merchant is not authorized to be using an actual PAN, then the transaction may be rejected at step 462. A rejection message is returned to the merchant with a response code in the message indicating the reason for the rejection. In some cases, the merchant's policies regarding the safeguarding of credit card information may have been breached by an employee, and the rejection at step 462 may serve as an indicator to the merchant that its policies need to be reviewed and perhaps that its employees need to be re-trained. In other cases, the use of an actual PAN may reflect an employee (or a person not authorized by the merchant, but purporting to conduct a transaction on behalf of the merchant) is attempting to conduct a transaction that may involve fraud (e.g., the person may be attempting to conduct a fraudulent transaction at a merchant terminal, or at a terminal that is been disguised to look to the transaction processing system 124 as if it were a merchant terminal). Thus, at step 464 a notification is sent to the issuer indicating that an actual PAN has been attempted in a transaction, and that such transaction and circumstances should be evaluated for potential fraud involving the use of a cardholder's account information. In some cases, the issuer may contact the merchant for an investigation of the use of the PAN, and in other circumstances the use of the PAN may be considered in connection with other factors (report of stolen card information, other suspicious transactions involving the same PAN, etc.) to deem the transaction as likely fraudulent, notifying the cardholder and thereafter refusing subsequent transactions involving the same card/card number.

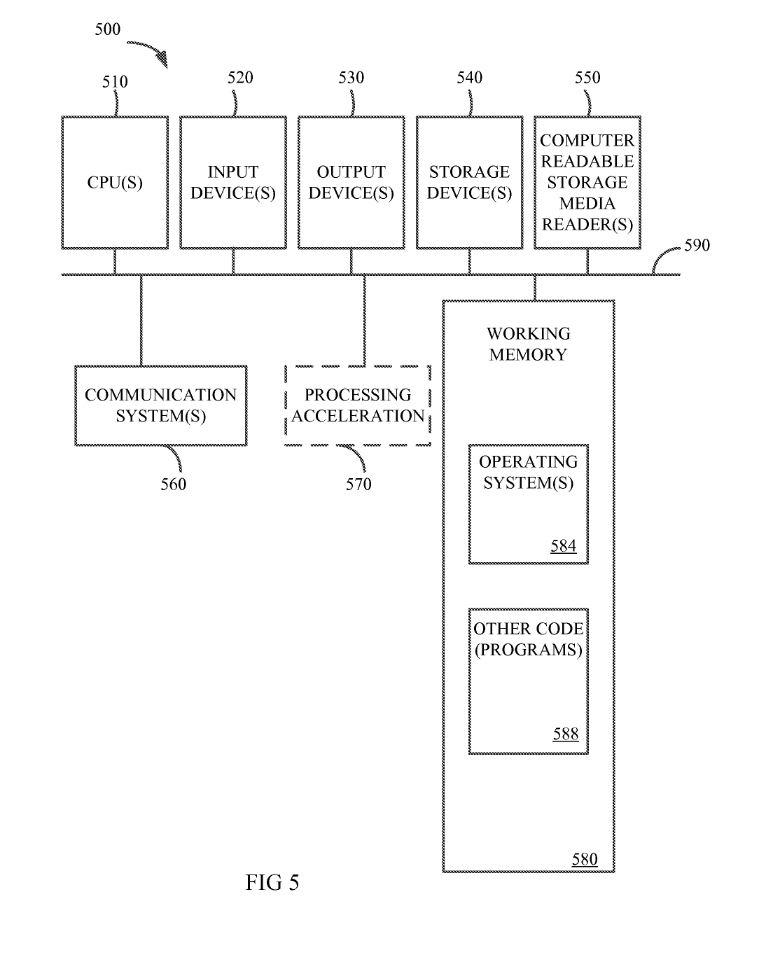

FIG. 5 is a block diagram illustrating an exemplary computer system upon which embodiments of the present invention may be implemented. This example illustrates a computer system 500 such as may be used, in whole, in part, or with various modifications, to provide the functions of the transaction processing system 124, as well as other components and functions of the invention described herein.

The computer system 500 is shown comprising hardware elements that may be electrically coupled via a bus 590. The hardware elements may include one or more central processing units 510, one or more input devices 520 (e.g., a mouse, a keyboard, etc.), and one or more output devices 530 (e.g., a display device, a printer, etc.). The computer system 500 may also include one or more storage devices 540, representing remote, local, fixed, and/or removable storage devices and storage media for temporarily and/or more permanently containing computer-readable information, and one or more storage media reader(s) 550 for accessing the storage device(s) 540. By way of example, storage device(s) 540 may be disk drives, optical storage devices, solid-state storage devices such as a random access memory (“RAM”) and/or a read-only memory (“ROM”), which can be programmable, flash-updateable or the like.

The computer system 500 may additionally include a communications system 560 (e.g., a modem, a network card—wireless or wired, an infra-red communication device, a Bluetooth™ device, a near field communications (NFC) device, a cellular communication device, etc.). The communications system 560 may permit data to be exchanged with a network, system, computer, mobile device and/or other component as described earlier. The system 500 also includes working memory 580, which may include RAM and ROM devices as described above. In some embodiments, the computer system 500 may also include a processing acceleration unit 570, which can include a digital signal processor, a special-purpose processor and/or the like.

The computer system 500 may also comprise software elements, shown as being located within a working memory 580, including an operating system 584 and/or other code 588. Software code 588 may be used for implementing functions of various elements of the architecture as described herein. For example, software stored on and/or executed by a computer system, such as system 500, can be used in implementing the processes seen in FIGS. 2, 4A and 4B, as well as functions of the Message Evaluation Application described in conjunction with FIG. 4A.

It should be appreciated that alternative embodiments of a computer system 500 may have numerous variations from that described above. For example, customized hardware might also be used and/or particular elements might be implemented in hardware, software (including portable software, such as applets), or both. Furthermore, there may be connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the merchant system 120 and transaction processing system 124 may each be implemented by a single system having one or more storage device and processing elements. As another example, the merchant system 120 and transaction processing system 124 may each be implemented by plural systems, with their respective functions distributed across different systems either in one location or across a plurality of linked locations.

Moreover, while the various flows and processes described herein (e.g., those illustrated in FIGS. 2, 4A and 4B) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method for processing a transaction against an account having an account identifier, comprising:
receiving, at a transaction processing system, an authorization request message from a merchant system, the authorization request message including a token for use in lieu of an account identifier, the token provided to the merchant system by a tokenization service and linked to the account identifier for the account;
providing, to the tokenization service by the transaction processing system, the token in the authorization request message received from the merchant system;
receiving, by the transaction processing system from the tokenization service, the account identifier linked to the token; and
forwarding, by the transaction processing system to a financial institution maintaining the account, the authorization request message, the forwarded authorization request message including the account identifier linked to the token.

2. The method of claim 1, further comprising:
determining, at the transaction processing system, that the token is present in the authorization request message received from the merchant system.

3. The method of claim 1, wherein the transaction is a card transaction and wherein the account identifier is a primary account number (PAN).

4. The method of claim 3, further comprising:
receiving, from a cardholder, the PAN at the merchant system;
receiving, by the merchant system, a token from the tokenization service that corresponds to the PAN; and
storing, at the merchant system, the received token for use in the authorization request message.

5. The method of claim 1, wherein the authorization request message includes a PAN field, and wherein the method further comprises:
placing, by the merchant system, the token provided by the tokenization service in the PAN field of the authorization request message.

6. The method of claim 5, further comprising:
evaluating, at the transaction processing system, the PAN field to determine whether a token is present in the PAN field.

7. The method of claim 6, wherein the data on the PAN field includes a bank identification number (BIN), and wherein the BIN indicates the presence of a token in the PAN field.

8. The method of claim 6, wherein the token placed in the PAN field includes a marker bit to indicate the presence of a token in the PAN field.

9. The method of claim 8, wherein the token placed in the PAN field has the same number of bits as the PAN, and wherein the marker bit is represented by a value in the first bit of the token placed in the PAN field.

10. The method of claim 9, further comprising:
receiving, at the transaction processing system, from the financial institution maintaining the account, an authorization response message, wherein the authorization response message includes the PAN;
requesting, by the transaction processing system from the tokenization service, the token corresponding to the PAN;
placing, by the transaction processing system, the token in the authorization response message for use in lieu of the PAN; and
forwarding the authorization response message, with the token for use in lieu of the PAN, from the transaction processing system to the merchant system.

11. The method of claim 1, wherein the tokenization service is provided at the transaction processing system.

12. The method of claim 1, wherein the account is associated with an instrument selected from a group consisting of a credit card, debit card, check card, loyalty card, ATM card, gift card, stored value card, and key fob.

13. A system for processing card transactions, comprising:
one or more processors; and
a memory, the memory storing instructions executable by one or more of the processors and configuring the system for:
receiving, at a transaction processing system, an authorization request message from a merchant system, the authorization request message including a token for use in lieu of an account identifier, the token provided to the merchant system by a tokenization service and linked to the account identifier for the account;
providing, to the tokenization service by the transaction processing system, the token in the authorization request message received from the merchant system;
receiving, by the transaction processing system from the tokenization service, the account identifier linked to the token; and
forwarding, by the transaction processing system to a financial institution maintaining the account, the authorization request message, the forwarded authorization request message including the account identifier linked to the token.

14. The system of claim 13, wherein the instructions further configure the system for:
determining, at the transaction processing system, that the token is present in the authorization request message received from the merchant system.

15. The system of claim 13, wherein the transaction is a card transaction and wherein the account identifier is a primary account number (PAN).

16. The system of claim 15, wherein the instructions further configure the system for:
receiving, from a cardholder, the PAN at the merchant system;
receiving, by the merchant system, a token from the tokenization service that corresponds to the PAN; and
storing, at the merchant system, the received token for use in the authorization request message.

17. The system of claim 13, wherein the authorization request message includes a PAN field, and wherein the instructions further configure the system for:
placing, by the merchant system, the token provided by the tokenization service in the PAN field of the authorization request message.

18. The system of claim 17, wherein the instructions further configure the system for:
evaluating, at the transaction processing system, the PAN field to determine whether a token is present in the PAN field.

19. The system of claim 18, wherein the data in the PAN field includes a bank identification number (BIN), and wherein the BIN indicates the presence of a token in the PAN field.

20. The system of claim 18, wherein the token placed in the PAN field includes a marker bit to indicate the presence of a token in the PAN field.

21. The system of claim 20, wherein the token placed in the PAN field has the same number of bits as the PAN, and wherein the marker bit is represented by a value in the first bit of the token placed in the PAN field.

22. The method of claim 21, wherein the instructions further configure the system for:
receiving, at the transaction processing system, from the financial institution maintaining the account, an authorization response message, wherein the authorization response message includes the PAN;
requesting, by the transaction processing system from the tokenization service, the token corresponding to the PAN;
placing, by the transaction processing system, the token in the authorization response message for use in lieu of the PAN; and
forwarding the authorization response message, with the token for use in lieu of the PAN, from the transaction processing system to the merchant system

23. The system of claim 13, wherein the tokenization service is provided at the transaction processing system.

24. A method for processing a transaction against an account having an account identifier, comprising:
receiving, at a transaction processing system, an authorization request message from a merchant system, the authorization request message including a token for use in lieu of an account identifier, the token provided to the merchant system by a tokenization service and linked to the account identifier for the account;
determining, at the transaction processing system, whether an authorization request message received at the transaction processing system includes a token in the account identifier field in lieu of the account identifier;
if the authorization request message received at the transaction processing system includes a token in the account identifier field, processing the transaction at the transaction processing system, against an account identified by the account identifier linked to the token in the account identifier field, including:
providing, to the tokenization service by the transaction processing system, the token in the authorization request message received from the merchant system;
receiving, by the transaction processing system from the tokenization service, the account identifier linked to the token; and
forwarding, by the transaction processing system to a financial institution maintaining the account, the authorization request message, the forwarded authorization request message, with the account identifier received from the tokenization service replacing the token in the account identifier field; and
if the authorization request message received at the transaction processing system does not include a token in the account identifier field, rejecting the transaction at the transaction processing system, including providing an authorization response message to the merchant with a rejection reason code indicting that the account identifier field includes an account identifier rather than a token.
